(19) United States
(12) Patent Application Publication
(10) Pub. No.: US 2017/0343972 A1
(43) Pub. Date: Nov. 30, 2017

(54) INTERACTIVE INTELLECTUAL ROOM ASSISTANT SYSTEMS AND METHOD

(71) Applicants: JaQuar McMickle, Antioch, TN (US); Guy Stanford, Clarksville, TN (US)

(72) Inventors: JaQuar McMickle, Antioch, TN (US); Guy Stanford, Clarksville, TN (US)

(21) Appl. No.: 15/610,603

(22) Filed: May 31, 2017

Related U.S. Application Data
(60) Provisional application No. 62/343,820, filed on May 31, 2016.

(51) Int. Cl. G05B 15/02; H04L 12/28; G06Q 50/12; H04W 4/20; H04L 29/08

(52) U.S. Cl. CPC G05B 15/02; H04W 4/20; H04L 67/306; G06Q 50/12; H04L 67/18; H04L 12/282; H04L 67/22

(57) ABSTRACT

An interactive intellectual room assistant is disclosed herein. The interactive intellectual room assistant includes a communication network, a server, a guest client device, a room client device, and at least one room receiver. The server is communicably coupled to the communication network, and configured to provide services to the guest. The server includes both a database configured to provide locality information to the guest and a control module configured to adjust at least one room control of the room via a control signal.

### CROSS-REFERENCE TO RELATED APPLICATION

The present application is related to and claims priority to U.S. Provisional Patent Application No. 62/343,820 filed May 31, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of remote controllers and more specifically relates to interactive remote controllers.

### 2. Description of Related Art

When some people rent a hotel room, they are located in an unfamiliar area. It may be difficult to obtain up-to-date information on restaurants, recreation, and other entertainment in the area. Hotels have concierges which can give people information; however, it may be frustrating to have to go downstairs to a lobby in order to contact them. Further, there may be some aspects of a hotel room which are unfavorable for some such as temperature, wake-up calls, and the like. A suitable solution is desired.

U.S. Pub. No. 2007/0050197 to Edward Efron et al. relates to a system and method of interacting with hotel information and services. The described system and method of interacting with hotel information and services includes an automated system and a method for interacting with hotel information and hotel services using client terminal devices. The client terminal devices may be located in hotel guest rooms, at the front desk, or in public areas throughout the hotel. The user may be automatically authenticated or the user may be prompted to enter authentication information. Upon authentication, the user is provided with a plurality of icons for obtaining information regarding accounting services, scheduling a banquet, concierge services, engineering services, front desk services, general manager services, housekeeping services, meeting room services, restaurant services, room service, security services, wake-up call services, outside call services, dial a guest services, guest services, or other services.

### BRIEF SUMMARY OF THE INVENTION

In view of the foregoing disadvantages inherent in the known automated service art, the present disclosure provides a novel interactive intellectual room assistant. The general purpose of the present disclosure, which will be described subsequently in greater detail, is to provide an interactive intellectual room assistant.

An interactive intellectual room assistant system is disclosed herein. The interactive intellectual room assistant includes a communication network, a server, a room client device, a guest client device, and at least one room receiver. The server is communicably coupled to the communication network, and configured to provide services to the guest. The server includes both a database configured to provide locality information to the guest and a control module configured to adjust at least one room control of the room via a control signal. The room client device includes a graphical user interface and is configured to access the communication network and receive a first input from a guest desiring to access the server. The service client device is also configured to connect a service personnel with the guest via the communication network. The at least one room receiver is configured to receive control signals from the server and to adjust comfort parameters of the room in response to a guest command.

According to another embodiment, a method of interacting with a room in a locality is also disclosed herein. The method of interacting with a room in a locality includes receiving a query for locality information from a guest into a room client device, or a mobile client device, communicating the query from the room client device, or the mobile client device to a server via a communications network, comparing the query to a database configured to provide locality information, communicating a response to the query for locality information to the room client device, or the mobile client device via the communication network; and displaying the response to the query for locality information to the guest via the first-graphical-user-interface of the room client device or a second-graphical-user-interface of the mobile client device.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, an interactive intellectual room assistant, constructed and operative according to the teachings of the present disclosure.

FIG. 1 is a schematic diagram of the interactive intellectual room assistant during an ‘in-use’ condition, according to an embodiment of the disclosure.

FIG. 2 is a schematic diagram of the interactive intellectual room assistant of FIG. 1, according to an embodiment of the present disclosure.

FIG. 3 is a schematic diagram of the interactive intellectual room assistant of FIG. 1, according to an embodiment of the present disclosure.

FIG. 4 is a schematic diagram of the interactive intellectual room assistant of FIG. 1, according to an embodiment of the present disclosure.

FIG. 5 is a flow diagram illustrating a method for providing locality information and room services to a guest, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to an automated service and more particularly to an interactive intellectual room assistant as used to improve the provide locality information and room services to a guest.

Generally, the present disclosure provides hotels with a ‘smart room’ that enhances the quality of convenience and comfort by allowing customers to adjust room settings to their personal preferences. It utilizes an interactive wall monitor and a mobile application to effectively connect the hotel customer with the concierge at all times. It may include Bluetooth connections within the room, offering a way for individuals to utilize their technological devices such as smart phones, tablets, laptops, and the like in a more efficient manner. This may allow customers to familiarize themselves with an unfamiliar area via a local search for food, recreation, and other entertainment through voice recognition and commands. The present disclosure offers a way for frequent travelers to stay in a high-quality hotel room and get the most out of their traveling experience with minimal frustration and hassle.

Intelligent interactive intellectual room assistant is a uniquely-designed host system for hotel rooms. There can be two monitors per room with hidden speakers and microphones in every area of the room. The screens can be similar to tablets in which each device can function as a touch-screen. There may also be Bluetooth capabilities integrated within each room. Users can activate the system via the touch screen or remote controls.

Additionally, the intelligent interactive intellectual room assistant may utilize a guest portal. The guest portal may include an application for managing the housekeeping schedule for a room so that housekeeping only services the room within time slots assigned by the guest. The guest may use the guest portal to specify times to permit housekeeping access to the room, or alternatively, the guest may specify times to prohibit housekeeping access to the room.

The database may also include a customer profile database having records in memory of past client transactions and client information. The guest may access their database with a secure account in order to streamline room check-in and service functions. If a guest already has an account, the action of logging into a customer account through the guest portal may automatically register a guest to a room, thereby eliminating the need to check-in with service personnel. The guest portal may automatically retrieve the client information from the customer profile database. In another instance, a guest who checks in prior to arriving may activate a beacon using the guest portal on a mobile device which notifies service personnel that the guest has arrived.

The system can connect users with a hotel concierge or give information about the city/town in which they are staying. The device may also be used to control different aspects of the room including bed settings, temperature, wake-up calls, and much more. The system is intended to offer convenience and efficiency when staying in an unfamiliar area. Exact specifications of the intelligent interactive intellectual room assistant may vary upon further development and manufacturing.

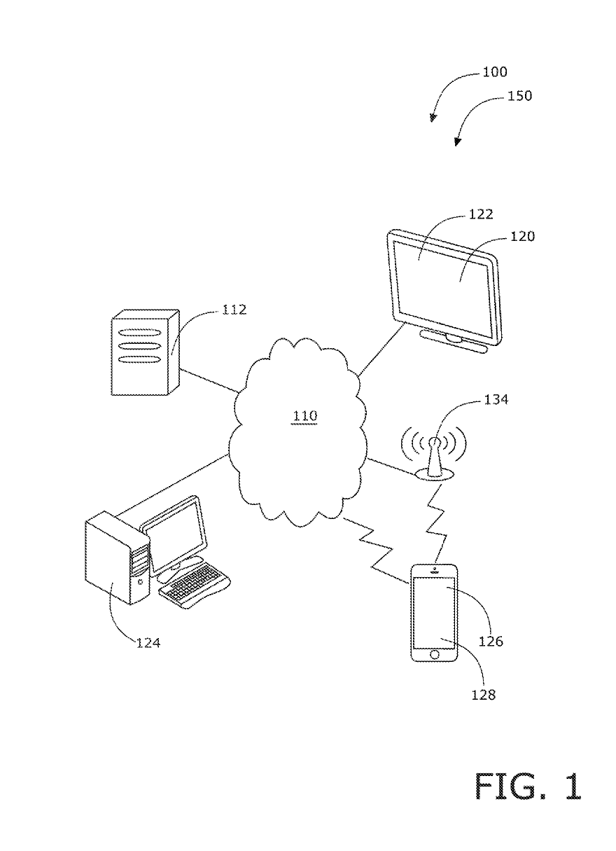

Referring now more specifically to the drawings by numerals of reference, there is shown in FIGS. 1-4, various views of an interactive room assistant/room service system (interactive intellectual room service system 100).

FIG. 1 shows an interactive intellectual room assistant during an ‘in-use’ condition 150, according to an embodiment of the present disclosure. As illustrated, interactive room service system 100 may include a communication network 110, a server 112, a room client device 120 having first-graphical-user-interface 122, a service client device 124, and a mobile client device 128 having second graphical-user-interface 126. The server 112 may be in communication with the room client device 120, the mobile client device 128, and the service client device 124 via the communication network 110. The communication network 110 may include a local area network being wireless or non-wireless, or a combination thereof.

The service client device 124 may be configured to communicate over communication network 110 via the first-graphical-user-interface 122 to access server 112. Mobile client device 128 may be configured to communicate over communication network 110 via second-graphical-user-interface 126 to access server 112. Room receiver 134 may be configured to receive a command or signal from server 112 to perform a task. Interactive room service system 100 may be configured to operate in at least one of a hotel, a university dormitory, or a community home.

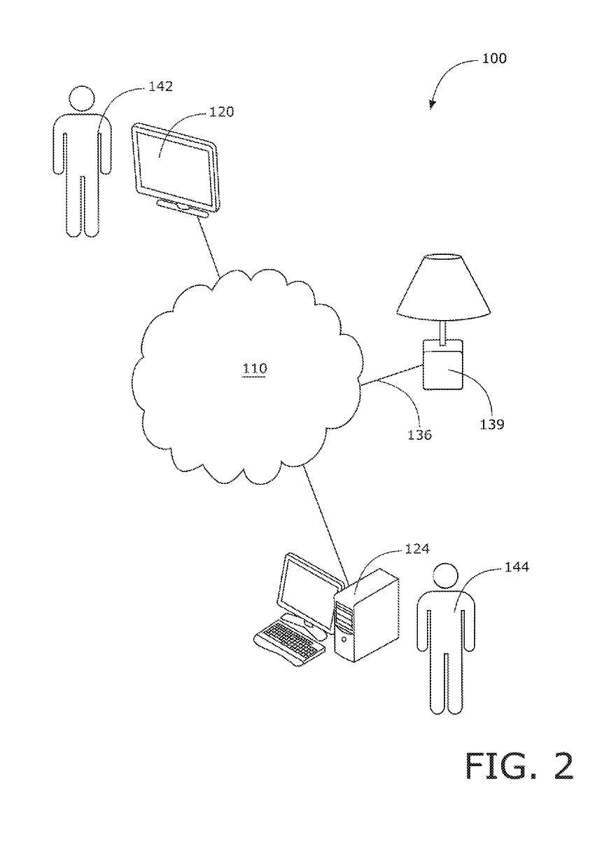

As shown in FIG. 2, the interactive intellectual room assistant may be beneficial to provide locality information and room services to a guest 142. As illustrated, interactive room service system 100 may include a communication network 110, a server 112, a room client device 120, a service client device 124, and at least one room control 139. The server 112 may include a control module 116 configured to adjust at least one room control 139 of the room via a control signal 136. The server 112 is communicably coupled to communication network 110 and provides services to the guest 142. Communications network 110 may also be configured to connect user 142 with service personnel 144 via the communication network 110.

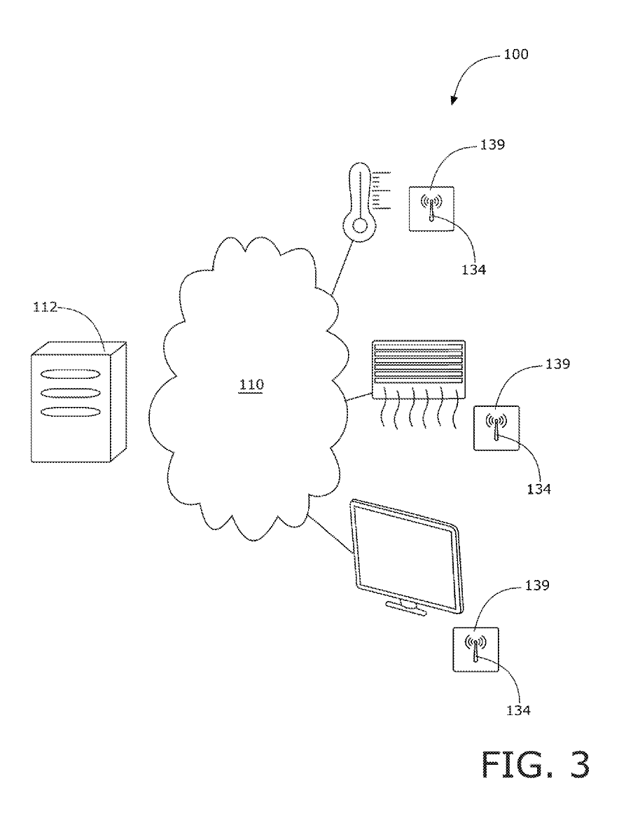

FIG. 3 further illustrates the interactive intellectual room assistant of FIG. 1 according to an embodiment of the present disclosure. As above, the at least one room control 139 may be configured to control different aspects of the room (e.g., lighting, temperature, fan speeds, television/media, bed settings, etc.). Here, the at least one room control 139 may a room receiver 134 that is configured to receive the control signal 136 (FIG. 2) from the server 112 via communications network 110 (e.g., wirelessly), and to adjust the different aspects of the room.

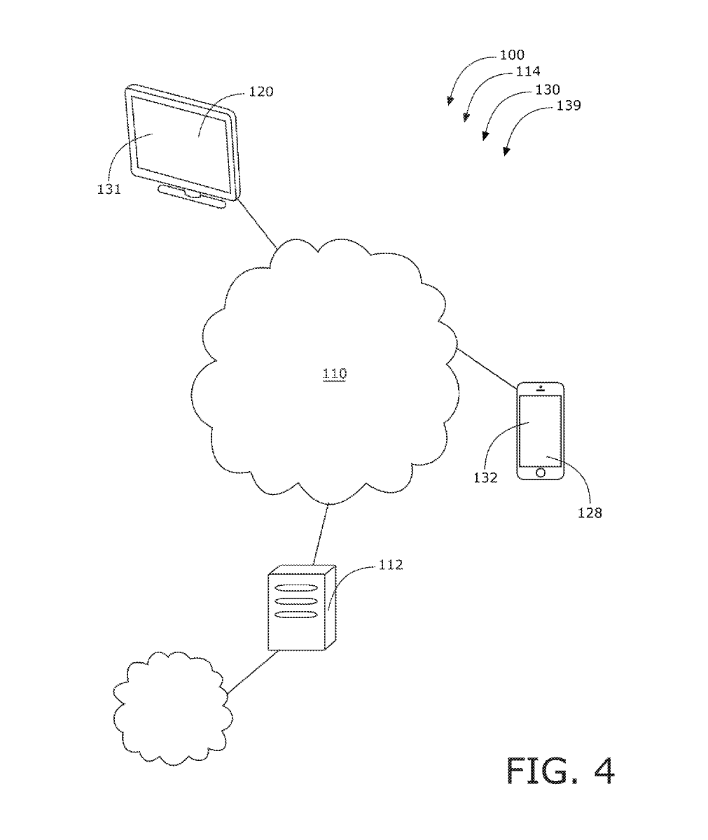

FIG. 4 is a view of the interactive intellectual room assistant of FIG. 1, according to an embodiment of the present disclosure. Server 112 may include a database 114 configured to provide locality information. Database 114 may include locality information stored therein. Database 114 may further include a customer profile database having record of past client transactions and personal information. Server 112 may include a guest portal 130 configured to searchably interface with database 114, to receive a query for locality information stored in database 114, to adjust at least one room control 139, to provide locality information in response to the query, and to display locality information on mobile client device 128 and room client device 120. Room client device 120 receiving first input 131 and mobile client device 128 receiving second input 132 may be configured to display a list of restaurants, a list of tourist attractions, a local map, a list of local businesses, or any combination thereof.

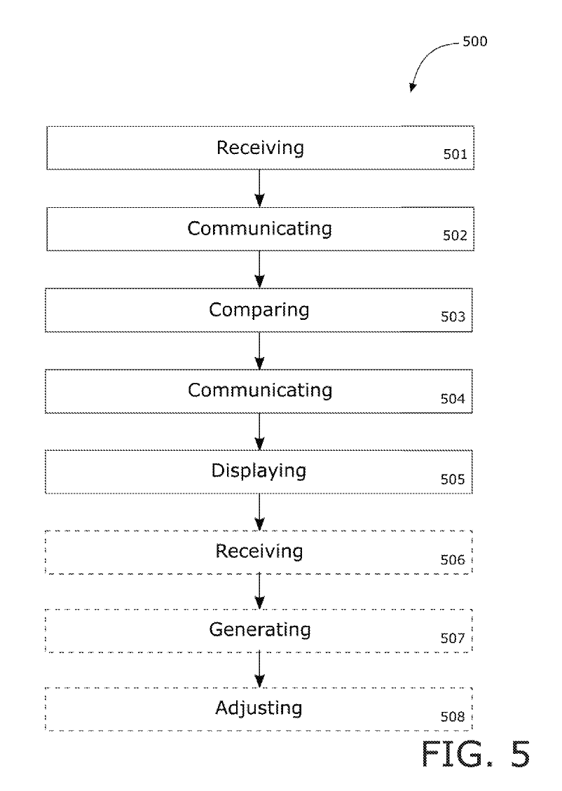

FIG. 5 is a flow diagram illustrating a method for provide locality information and room services to a guest, according to an embodiment of the present disclosure. In particular, the method for provide locality information and room services to a guest 500 may include one or more components or features of the interactive intellectual room assistant 100 as described above.

As illustrated, method of interacting with a room in a locality 500 may comprise the steps of: step 501 receiving a query for locality information from guest 142 into room client device 120, or mobile client device 128; step 502 communicating the query from room client device 120, or mobile client device 128 to server 112 via communications network; step 503 comparing the query to database 114 configured to provide locality information; step 504 communicating a response to the query for locality information to room client device 120, or mobile client device 128 via communication network 110; and step 505 displaying the response to the query for locality information to guest 142 via first-graphical-user-interface 122 of room client device 120 or second-graphical-user-interface 126 of mobile client device 128.

Optionally, method of interacting with a room in a locality 500 may also include step 506 receiving a room control request from the guest 142 via the room client device 120 or mobile client device 128; step 507 generating a control signal 136 in response to room control request from guest 142; and step 508 adjusting at least one room control 139 of room in response to control signal 136.

It should be noted that steps 506, 507, and 508 are optional steps and may not be implemented in all cases. Optional steps of method of use 500 are illustrated using dashed lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for provide locality information and room services to a guest (e.g., different step orders within above-mentioned list, elimination or addition of certain steps, including or excluding certain maintenance steps, etc.), are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An interactive room service system for a room of a guest, the interactive room service system comprising:
a communication network;
a server communicably coupled to the communication network, and
configured to provide services to the guest, the server including
a database configured to provide locality information to the guest, and
a control module configured to adjust at least one room control of the room via a control signal;
a room client device including a first-graphical-user-interface, the room client device being configured to access the communication network, the room client device configured to receive a first input from the guest via the first graphical-user-interface to access the server while in the room;
a service client device configured to communicate over the communication network, and to connect a service personnel with the guest via the communication network; and
at least one room receiver configured to receive the control signal from the server, and to adjust at least one comfort parameter of the room in response to the received control signal.

2. The interactive room service system of claim 1, further comprising a mobile client device including a second-graphical-user-interface, the mobile client device configured to communicate over the communication network, and to receive a second input from the guest via the second-graphical-user-interface to access the server.

3. The interactive room service system of claim 1, wherein the communication network includes a wireless communication network.

4. The interactive room service system of claim 1, wherein the communication network comprises a local area network.

5. The interactive room service system of claim 1, wherein the communication network includes a wireless local area network.

6. The interactive room service system of claim 1, wherein the at least one comfort parameter of the room includes at least one of a lighting level, a sound level, a temperature level, a fan level, a media selection, and a media output level.

7. The interactive room service system of claim 6, wherein the at least one room receiver is communicably coupled to a thermostat.

8. The interactive room service system of claim 6, wherein the at least one room receiver is communicably coupled to an air conditioning controller.

9. The interactive room service system of claim 6, wherein the at least one room receiver is communicably coupled to a ventilation controller.

10. The interactive room service system of claim 6, wherein the at least one room receiver is communicably coupled to a television controller.

11. The interactive room service system of claim 1, wherein the database includes the locality information stored therein;
wherein the server further includes a guest portal, the guest portal configured to searchably interface with the database,
to receive a query from the guest for the locality information stored in the database,
to provide the locality information to the guest in response to the query, and
to display the locality information on the first graphical-user-interface of the room client device.

12. The interactive room service system of claim 11, wherein the guest portal is further configured to display a list of restaurants.

13. The interactive room service system of claim 11, wherein the guest portal is further configured to display a list of tourist attractions.

14. The interactive room service system of claim 11, wherein the guest portal is further configured to display a local map.

15. The interactive room service system of claim 11, wherein the guest portal is further configured to display a list of local businesses.

16. The interactive room service system of claim 1, further comprising a mobile client device including a second graphical-user-interface, the mobile client device configured to communicate over the communication network, and to receive a second input from the guest via the second graphical-user-interface to access the server; and
wherein the guest portal is further configured to display the locality information on the second graphical-user-interface of the mobile client device.

17. An interactive room service system of claim 1, wherein the interactive room service system is configured to operate in at least one of a hotel, a university dormitory, or a community home.

18. A method of interacting with a room in a locality, the method comprising the steps of:
receiving a query for locality information from a guest into a room client device, or a mobile client device;
communicating the query from the room client device, or the mobile client device to a server via a communications network;
comparing the query to a database configured to provide locality information;
communicating a response to the query for locality information to the room client device, or the mobile client device via the communication network; and
displaying the response to the query for locality information to the guest via the first-graphical-user-interface of the room client device or a second-graphical-user-interface of the mobile client device.

19. The method of claim 19, further comprising the steps of
receiving a comfort parameter request from the guest via the room client device or the mobile client device;
generating a control signal in response to the comfort parameter request from the guest; and
adjusting at least one comfort parameter of the room in response to the control signal.
